(19) United States
(12) Patent Application Publication
(10) Pub. No.: US 2010/0063938 A1
(43) Pub. Date: Mar. 11, 2010

(54) SYSTEM AND METHOD FOR FINANCIAL DATA MANAGEMENT AND COMPUTATION

(75) Inventors: Yaron Y. Kantor, Tel Aviv (IL); Dror Orenstein, Raanana (IL)

Correspondence Address: OLIFF & BERRIDGE, PLC, P.O. BOX 320850, ALEXANDRIA, VA, 22320-4850, US

(73) Assignee: PROTAGONIS LTD., ROSH HA'AYIN (IL)

(21) Appl. No.: 12/529,922

(22) PCT Filed: Mar. 6, 2008
(86) PCT No.: PCT/IL2008/000295

§ 371 Date: Sep. 4, 2009

Related U.S. Application Data
(60) Provisional application No. 60/905,606, filed on Mar. 8, 2007.

(51) Int. Cl. G06Q 40/00; G06Q 50/00

(52) U.S. Cl. 705/36 R; 705/35

(57) ABSTRACT

A system and method for financial data management and computation is disclosed. In one embodiment, the system includes a financial storage module storing financial properties values, a metagraph module storing at least one sub-metagraph, a computation module, a metagraph complier module operatively coupled to the financial storage module, the metagraph module and the computation module, wherein the complier module is operatively configured to: (a) receive one or more financial entity groups, each having at least one group criterion, the financial entity group being associated with at least one sub-metagraph; (b) obtain financial data from the financial storage module (c) relate the financial data with at least one of the financial entity groups if the financial data complies with the group criterion thereby giving rise to at least one relevant financial entity groups (d) obtain sub-metagraphs associated with the relevant financial entity groups from the metagraph module giving rise to relevant sub-metagraphs (e) derive execution graphs from the relevant sub-metagraphs and (f) send the execution graphs for execution in the computation module, whereby financial information is updated and financial actions are performed according to the financial data.

### FIELD OF THE INVENTION

This invention relates to the field of financial data systems.

### BACKGROUND OF THE INVENTION

Strategies for computer assisted trading of financial instruments take advantage of computation and communication technologies in order to generate profits. Computer assisted trading is driving trading volume (e.g the total number of contracts traded in a set period of time) to unprecedented highs, having risen 1,750 percent from 2003 to 2005. In fact, volumes more than doubled during 2005 alone, and are projected to continue growing exponentially.

Most of the trading activities take place in electronic online trading arenas where the high availability of information and the abundance of computerized automated trading results in fierce competition, swift market responses and minimal profit spread for the participating members.

Dynamic parameters associated with financial markets should be constantly traced and updated in realtime, based on a constant flow of market events such as trading events. A key challenge in trading is to accurately evaluate the “correct” values of dynamic parameters.

An example of such a dynamic parameter is the value that best reflects the true price of a financial instrument (the terms “financial entity” or “instrument” are also used throughout the text). Since many trading events of a financial instrument may take place at the same time (or at very close times) and each such event may carry a different price, there exists a need to determine an estimated value that best evaluates the price. This should be carried out for each instrument in realtime in order to identify emerging opportunities and risks. Erroneous value determination of instruments may be exploited by other members who take advantage of more accurate or faster systems. In this case, the technological superiority of such other members would result in a fast and significant capital loss to the member who made the error. There are thousands of financial instruments traded concurrently in the various markets; all of them need to be evaluated continuously and consistently. Continuous profitable trading is achieved when the values of all instruments are coherent and up-to-date when required, and trades are executed accordingly.

During trading hours, the various instruments are traded in the markets at various prices. Each time the price of an instrument is set in the market, (i.e. a deal was made regarding the selling and buying of the instrument for a defined price), it might affect the prices of other, related instruments. Consistent pricing is achieved when all the inter-related financial instruments' values are mutually coherent (i.e. there is no financial inconsistency among the values), For example, determined prices of instruments that include an interest component such as fixed income instruments have high-correlation between them. e.g., the price of a 9-year US government bond should be re-determined when the price of the 10-year US government bond changes, Moreover, the price of a 10-year AAA corporate bond, e.g. IBM, should also reflect the change of the price of the 10-year US government bond, and so on.

Therefore, the trading & pricing system must continuously compute the prices of an enormous number of instruments.

Trading and pricing systems are in charge of evaluating market values for the instruments in realtime. In today's market conditions this has become an increasingly difficult task as each instrument's price is affected by thousands of events per second across the different markets.

### SUMMARY OF THE INVENTION

In accordance with an embodiment of the invention there is provided a method for managing financial data, the method comprising:
a) providing at least one financial entity group having at least one group criterion, said financial entity group being associated with at least one sub-metagraph;
b) obtaining financial data;
c) relating said financial data to at least one of said financial entity groups if said financial data complies with said group criterion thereby giving rise to at least one relevant financial entity group;
d) obtaining sub-metagraphs associated with said relevant financial entity groups giving rise to relevant sub-metagraphs;
e) deriving execution graphs from said relevant sub-metagraphs; and
f) executing said execution graphs whereby financial information is updated and financial actions are performed according to said financial data.

In accordance with an embodiment of the invention there is further provided a system for managing financial data, the system comprising:
a financial storage module storing financial properties values;
a metagraph module storing at least one sub-metagraph;
a computation module;
a metagraph complier module operatively coupled to said financial storage module, said metagraph module and said computation module;
wherein said complier module is operatively configured to:
   a) obtain at least one sub-metagraph from said metagraph module, said at least one sub-metagraph comprising at least one financial property;
   b) obtain values associated with said at least one financial property from said financial storage module;
   c) produce at least one execution graph based on said at least one sub-metagraph and said values; and
   d) send said at least one execution graph to said computation module for execution thereby;
      whereby financial information is updated and financial actions are performed according to said financial data.

In accordance with an embodiment of the invention there is still further provided a system for managing financial data, the system comprising:
a financial storage module storing financial properties values;
a metagraph module storing at least one sub-metagraph;
a computation module;
a metagraph complier module operatively coupled to said financial storage module, said metagraph module and said computation module;
wherein said complier module is operatively configured to:
   a) receive one or more financial entity groups, each having at least one group criterion, said financial entity group being associated with at least one sub-metagraph;
   b) obtain financial data from said financial storage module;
   c) relate said financial data with at least one of said financial entity groups if said financial data complies with said group criterion thereby giving rise to at least one relevant financial entity groups;
   d) obtain sub-metagraphs associated with said relevant financial entity groups from said metagraph module giving rise to relevant sub-metagraphs;
e) derive execution graphs from said relevant sub-metagraphs; and
f) send said execution graphs for execution in said computation module;
   whereby financial information is updated and financial actions are performed according to said financial data.

In accordance with an embodiment of the invention there is still further provided a program storage device readable by machine, tangibly embodying a program of instructions executable by the machine to perform method steps for managing financial data, the method comprising:
a) providing at least one financial entity group having at least one group criterion, said financial entity group being associated with at least one sub-metagraph;
b) obtaining financial data;
c) relating said financial data to at least one of said financial entity groups if said financial data complies with said group criterion thereby giving rise to at least one relevant financial entity group;
d) obtaining sub-metagraphs associated with said relevant financial entity groups giving rise to relevant sub-metagraphs;
e) deriving execution graphs from said relevant sub-metagraphs; and
f) executing said execution graphs.

In accordance with an embodiment of the invention there is still further provided a computer program product comprising a computer useable medium having computer readable program code embodied therein for managing financial data, the computer program product comprising:
a) computer readable program code for causing the computer to provide at least one financial entity group having at least one group criterion, said financial entity group being associated with at least one sub-metagraph;
b) computer readable program code for causing the computer to obtain financial data;
c) computer readable program code for causing the computer to relate said financial data to at least one of said financial entity groups if said financial data complies with said group criterion thereby giving rise to at least one relevant financial entity group;
d) computer readable program code for causing the computer to obtain sub-metagraphs associated with said relevant financial entity groups giving rise to relevant sub-metagraphs;
e) computer readable program code for causing the computer to derive execution graphs from said relevant sub-metagraphs; and
f) computer readable program code for causing the computer to execute said execution graphs.

In accordance with an embodiment of the invention there is still further provided a method for managing financial data, the method comprising:
a) providing consolidated business scenarios that pertain to at least one financial instrument;
b) receiving financial data that pertain to at least one financial instrument;
c) checking if the financial data relates to at least one of the consolidated business scenarios giving rise to relevant business scenarios; and
d) computing the relevant business scenarios;
whereby financial information is updated and financial actions are performed according to said financial data.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram illustrating system architecture according to certain embodiments of the present invention;

FIG. 2 is a schematic illustration of a financial storage module in accordance with certain embodiments of the present invention;

FIG. 3 is a schematic illustration of an execution graph associated with one of the financial entities in the financial storage module of FIG. 2, in accordance with certain embodiments of the present invention;

FIG. 4 is a schematic illustration of a financial entity group and its associated sub-metagraph of a financial entity from the financial storage module of FIG. 2, in accordance with certain embodiments of the present invention;

FIG. 5 is a flowchart diagram of a general sequence of operations of a system according to certain embodiments of the present invention;

FIG. 5 is a flowchart diagram according to a certain embodiment of the present invention;

FIG. 6 is a schematic illustration of the simplified financial storage module representation of FIG. 2, in which the effect of the execution of the execution graph of FIG. 3 is illustrated, in accordance with certain embodiments of the present invention;

FIG. 7 is a schematic illustration of a sub-metagraph in accordance with certain embodiments of the present invention, based on the sub-metagraph of FIG. 4 wherein a second financial entity group and the corresponding sub-metagraph are introduced;

FIG. 8 is a schematic illustration of an execution graph corresponding to the sub-metagraph of FIG. 7, in accordance with certain embodiments of the present invention;

FIG. 9 is a schematic illustration of the simplified financial storage module of FIG. 6, in which the effect of the execution of the execution graph of FIG. 8 is illustrated, in accordance with certain embodiments of the present invention;

FIG. 10 is a schematic illustration of a representation of a sub-metagraph in accordance with certain embodiments of the present invention, based on the sub-metagraph of FIG. 7 wherein a third financial entity group and the corresponding sub-metagraph are introduced;

FIG. 11 is a schematic illustration of an execution graph corresponding to the sub-metagraph of FIG. 10, in accordance with certain embodiments of the present invention; and

FIG. 12 is a schematic illustration of the simplified financial storage module of FIG. 9, in which the effect of the execution of the execution graph of FIG. 11 is illustrated, in accordance with certain embodiments of the present invention.

### DETAILED DESCRIPTION OF EMBODIMENTS

The principles and operation of the system according to the present invention may be better understood with reference to the drawings and accompanying description. Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

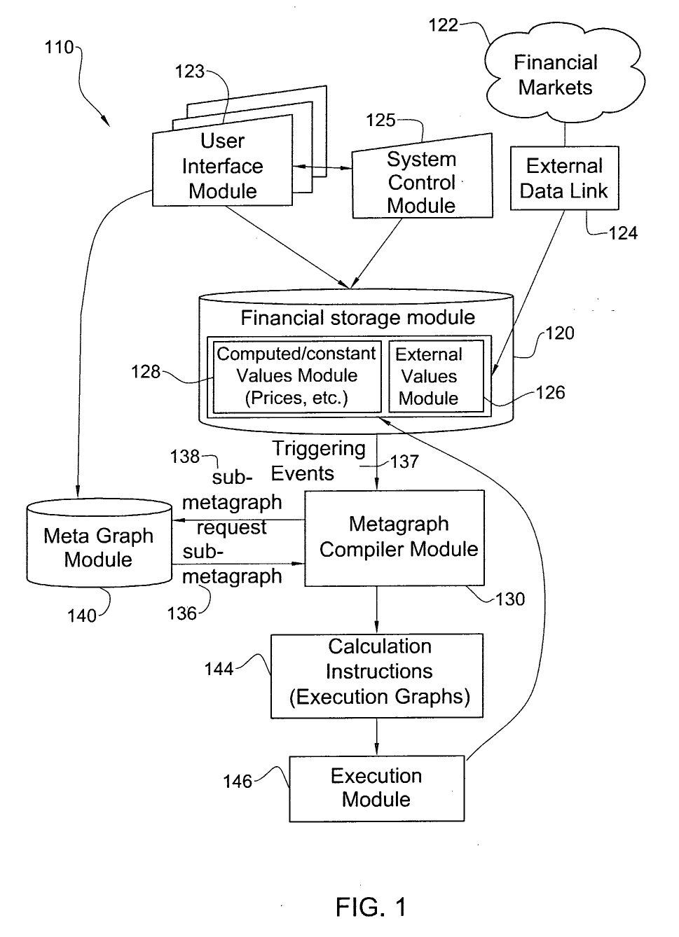

FIG. 1 is a block diagram illustrating system architecture according to certain embodiments of the present invention.

System 110 comprises a financial storage module 120 receiving data from financial markets 122 by way of an external data link 124 as well as data from a system control module 125 linked to a user interface module 123. According to certain embodiments of the present invention, the data provided to the system is received directly from the markets. According to certain other embodiments of the present invention, the data provided to the system is derived from the original data, and may be processed or manipulated by intermediate external systems without limiting the scope of the invention. Data received from the financial markets is stored in the External Values module 126. Data other than the received data is stored in the computed and constant values module 128. The financial storage module is operatively coupled to the metagraph compiler module 130. According to certain embodiments of the present invention, new data received from the financial markets that causes a change in one of the values stored at the External Values module may induce a triggering event 137 that reaches the metagraph compiler module 130. The metagraph compiler module 130 communicates with the Meta graph module 140, sends a sub-metagraph request 138 and receives the relevant sub-metagraph 136 as will be later explained. If a change in one of the values stored in the financial storage triggers a computation or execution operation, the metagraph compiler module produces an “execution graph” in the form of instructions 144 as will be explained below. The execution module 146 receives the instructions, performs the required actions and computations and updates the financial storage accordingly. These updates may, in turn, cause additional triggering events 137.

The user interface module 123 allows manipulating the Meta graph module 140 and the data stored in the financial storage 120. The user interface module 123 also allows a user to interface with the system control module 125. According to certain embodiments of the present invention, the system control module 125 creates triggering events that are not directly related to financial markets events. For example, a change in the US central bank interest-rate, a change in the user's risk limit, or a change in the user's portfolio.

In a typical trading scenario, computations of values in the financial storage module 120 are continuously triggered by updates from the markets 122. An external trigger is initiated by an external event such as updates from the various markets. For example, if a financial instrument such as the 10-year US government bond was just traded in the ‘inter-dealer market’ at the price of $99.34, then the corresponding field in the external values module 126 is immediately updated. Furthermore, other values stored in the financial storage module 120 for the same or other financial instruments that are financially related to the 10-year bond are re-determined as well (e.g. the profitable prices to buy or sell the 10-year bond, the prices of the financial derivatives of this bond, prices of corporate 10-year bonds, and also prices of the 9-year bonds and 11-year bonds). These value changes might cause additional computations or executions—thus, each market event may cause a “chain reaction” of computations and executions.

The system continuously updates the prices and other related values of the parameters stored in the financial storage module 120.

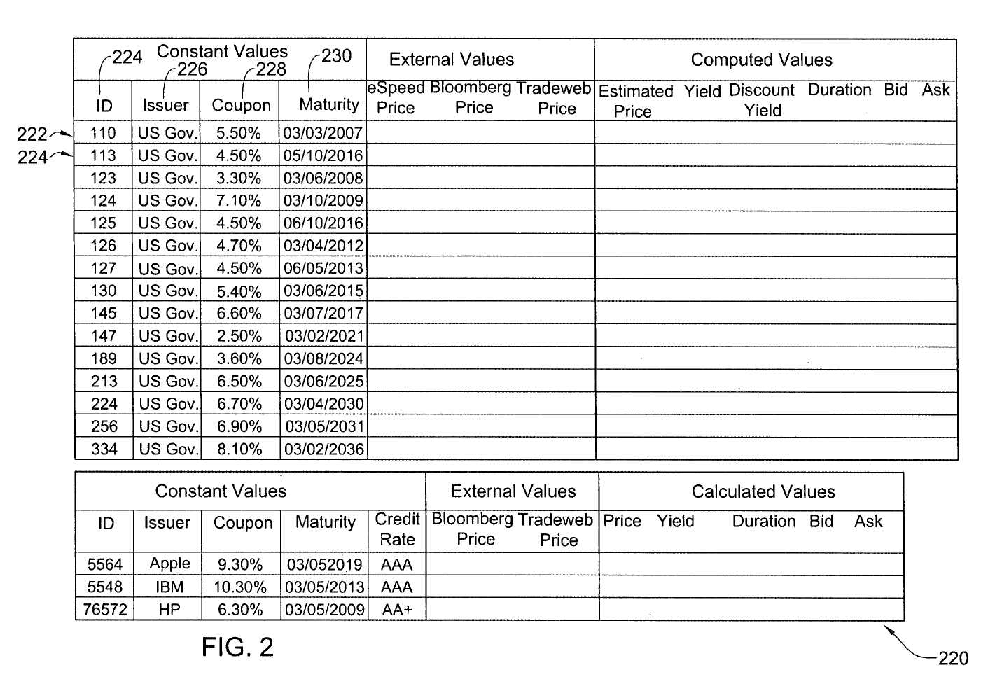

FIG. 2 is a a schematic illustration of a financial storage module in accordance with certain embodiments of the present invention.

Note that this is a simplified storage module intended to be used in an illustrative simplified way in the examples that follow.

Each financial instrument is represented as a row in the storage table 220. Each one of the attributes associated with a financial instrument is represented by a column. For example, row 222 represents the instrument whose ID value is 110 and issuer value is US Gov. In the example, the storage module of financial instruments contains only 18 bonds, 15 of them are issued by the US government (ID=110 to 334) and three by corporate: IBM or HP (ID=5564 to 76572).

Each financial instrument is associated with a list of values. In accordance with certain embodiments of the present invention, the values are divided to 3 types: constant values, external values and computed values.

Constant values are the instrument's related values which are not likely to change throughout its lifespan. Examples of constant values include the instrument's identifier (ID) 224 which is an internal reference number used in the system, the name of the instrument's issuer 226 (e.g. US Gov. in the case of a bond issued by the US government), coupon value 228 (represent semi-annual interest payments), maturity 230 (the length of time until the principal amount of a bond must be repaid) etc.

Computed values are values that may dynamically change in realtime. According to certain embodiments of the present invention, at the system initiation stage, the storage module is loaded with predefined constant values. The computed values will be generated in realtime. According to certain other embodiments of the present invention, the computed values may also be initiated with initial-values, but for the sake of simplification only, they were intentionally left undefined in the particular example shown in FIG. 2.

According to certain embodiments of the present invention, triggering events include changes to the values of fields in the financial storage module that cause additional computation or execution. Once changed, these values trigger a trading action or a change in other values. For example, when the price value of a bond changes, it triggers the computation of the bond's yield value. An additional example is when the price value of the 10-year government bond changes, it triggers the computation of the price value of the IBM 10-year bond since the two prices are correlated through a financial rule.

When a triggering event occurs due to a change in a value in the financial storage module, a related execution task containing actions and computations is activated. This task can be described by a graph termed the “Execution graph”.

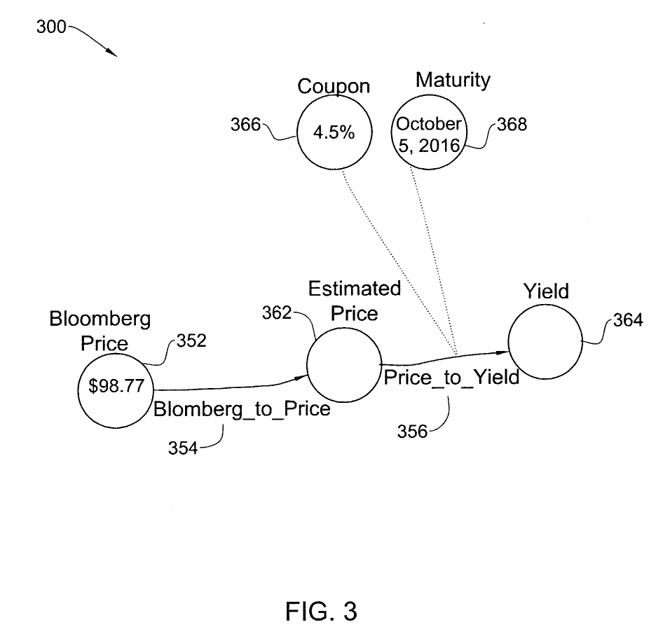

FIG. 3 is a schematic illustration of an execution graph associated with one of the financial entities in the financial storage module of FIG. 2, in accordance with certain embodiments of the present invention.

Execution graph 300 relates to a specific financial event: a trade in the 10 years US government bond (represented by row 224 in FIG. 2) that takes place on the online Bloomberg Arena. The Bloomberg Arena is an online “marketplace” in which financial institutions can buy and sell bonds.

The execution graph 300 is produced as a result of a financial event received in the system in which the data specified is:

[issuer=US Gov Bond; price=$98.77; coupon=4.5%; maturity=05/10/2016; market=Bloomberg]

Once a bond has been traded in the Bloomberg arena, one may want to use the new available information (e.g. the price the bond was traded) in the evaluation of the estimated price for that bond. The estimated price is a term denoting the price that best reflects the bond's true value. For example, the “Bloomberg price” value 352 (i.e. the price the bond was recently traded in the Bloomberg Arena), triggers a computation of the value of “estimated price” 362 using the “Bloomberg_to_Price” financial function 354. This financial function computes the estimated price of the bond once the “Bloomberg price” of the bond has changed. As explained before, a price of a bond is a dynamic value which constantly changes. In order to evaluate the estimated price, the financial function should reflect the financial interpretation of the event. In the example it is assumed the user of the system decided to have the “estimated price” evaluated as 5% higher than the Bloomberg traded price (The user's financial interpretation is that the Bloomberg market price is under-priced). Therefore, the financial function “Bloomberg_to_Price” will compute the “Bloomberg price” 352 multiplied by 1.05 and the result will be stored in the “estimated price” value 362. In a similar manner, once the “estimated price” value is changed, it causes the re-computation of another value: the “yield” value 364 (the effective rate of interest paid on a bond, computed by the coupon rate divided by the bond's market price). The “yield” will be computed based on the estimated price value by the “Price_to_Yield” financial function 356. Note that the function “Price_to_Yield” computes “yield” based on two additional parameters, namely the bond's attributes: “coupon” 366 and “maturity” 368. This is represented by the two broken lines leading from “coupon” 366 and “maturity” 368 to the “Price_to_Yield” function 356.

The previous example concerns the execution graph in the case of a specific trade. I.e. the 10-year US government Bond traded on the Bloomberg market with the following data received: [“issuer”=US Gov Bond; “price”=$98.77; “coupon”=4.5%; “maturity”=05/10/2016; “market”=Bloomberg]. In practice, financial markets provide a tremendous number of financial events, each one potentially triggering a specific computation in the form of an execution graph. Furthermore, a tremendous number of different financial entities (sometimes reaching thousands of entities or more) exist each is associated with specific computation logic.

According to certain embodiments of the present invention, a generalized abstraction of the execution graphs underlying rules (termed “metagraph”) is provided. A metagraph defines the underlying principles of the execution graphs, rather than having to define each and every execution graph separately for each and every instrument.

The metagraph describes a generalized pattern of computation that suits a group of instruments (termed “financial entity group” or “financial group”). From the metagraph, multiple specific execution graphs may be created by replacing the generalized building blocks (or elements) with specific instruments, functions and values as detailed below.

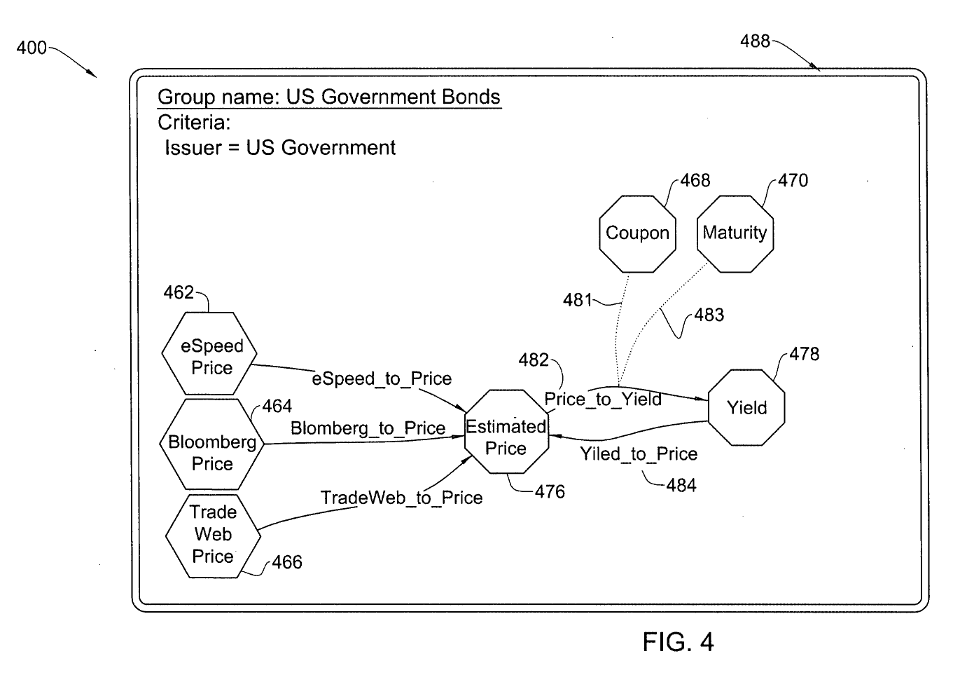

For example, FIG. 4 is a schematic illustration of a financial entity group and its associated sub-metagraph of a financial entity from the financial storage module of FIG. 2, in accordance with certain embodiments of the present invention.

The metagraph will be termed “sub-metagraph” from this point on in the context of the financial entity group in order to emphasize that it is only a part of the full metagraph defined in the system. This financial entity group and its associated sub-metagraph relate to a financial entity from the financial storage module of FIG. 2 (represented by row 224 in FIG. 2). The sub-metagraph also corresponds to the execution graph of FIG. 3, in accordance with certain embodiments of the present invention.

The sub-metagraph defines the general computation and execution process that relates to a general group of financial entities as will shortly be explained. The sub-metagraph of FIG. 4 relates to the financial entity group named “US Government Bonds” which includes any bond that is issued by the US government. This general execution process is triggered by any trade event of any member instrument of this financial entity group, in one of the three markets specified by the sub-metagraph (“eSpeed”, “Bloomberg” or “TradeWeb”).

Several types of metagraph elements may be used to define a metagraph:

In accordance with certain embodiments, a metagraph element termed “property” (the term “financial property” is also used throughout the text) is used as a basic building block in the definition of the metagraph. Properties are the general representation of instrument-related values as used in the metagraph. The financial properties are presented by an octagon in the metagraph representations in all of the following figures. The term “properties” is used in order to distinguish the abstract financial properties used in the metagraph from the specific values that take part in the actual executions and computations, as presented in the “execution graphs”. These values are represented by circles in the execution graphs. In accordance with certain embodiments of the present invention, properties are subcategorized into constant, external and computed categories; similarly to the way execution graphs' values are subcategorized.

The sub-metagraph of FIG. 4 contains three financial properties that may trigger computations and executions: the three properties that represent updates from the markets: “eSpeed price” 462, “Bloomberg price” 464 and “TradeWeb price” 466. The metagraph contains two properties of type constant, namely “coupon” 468 and “maturity” 470 (as previously explained, values of constant financial properties are not likely to change as a result of a trigger event). The sub-metagraph also contains computed properties, “estimated price” 476 and “yield” 478.

The change in the value of a property may trigger additional computations, thus causing the aforementioned “chain reaction”.

In accordance with certain embodiments of the present invention, a metagraph element termed “financial entity group” is another building block in the definition of a metagraph. Financial entity groups are groups of financial instruments that meet specific criteria (termed “financial entity group criteria”). In order to define which instruments belong to a financial entity group, financial entity group criteria are defined which usually uses a condition based on properties, e.g., to define the financial entity group that includes all the bonds issued by the US Government, a financial entity group with the criteria: “Issuer=US Government” will be provided. The members of this financial entity group are the financial entities whose constant property “Issuer” value is “US Government”. In all the following figures, financial entity groups are represented by a double frame 488 around the corresponding sub-metagraph, accompanied by a name and criteria. The sub-metagraph comprises a set of properties and financial functions (a term explained below). For example, financial entity group 400 is associated with a sub-metagraph applicable to the financial entity group named “US Government Bonds”. The relevant criteria rule is: “Issuer=US Government”. This implies that any financial instrument with the property “issuer” being equal to “US Government” is a member of the financial entity group. It also implies that any such financial instrument would be associated with the same sub-metagraph 400, and therefore would have the same properties and financial functions.

Importantly, an instrument can belong to more than one financial entity group, by matching a multiple financial entity groups' criterion, as will be further explained below.

For example, a financial entity of type 10-year US government bond (issued by the US government for a period of 10 years) with a “yield” property which equals to 4.7% belongs to the financial entity group “US Government bonds” (criteria is “issuer”=US Gov) and is also a member of the Financial entity group “Low yield bonds” (criteria is “yield”<5%).

In accordance with certain embodiments of the present invention, a metagraph element termed “financial function” is another basic building block used in the definition of the metagraph. Financial functions are functional dependencies between properties, i.e.—each time a property changes, it triggers financial functions (if they exist) that will re-compute other financial properties and/or perform additional operations. Financial functions are directional execution functions, leading from the earlier changed property to the financial properties that would be computed as a result. Financial functions are therefore presented by an arrow in all of the following figures, from the triggering property to the affected property. For example, the financial function “Price to Yield” 482 is triggered each time the property “estimated price” 476 changes. The financial function's computation output is stored in the property “yield” 478. When the financial function uses additional properties in order to perform the computation, the link to the additional property is presented as a dotted line. For example, in order to accomplish the computation, financial function 482 reads extra values stored in properties “coupon” 468 and “maturity” 470, e.g. in order to compute the “yield” (which is a positive number representing interest rate) from the bond “estimated price”, the bonds' “coupon” (original interest rate) and “maturity” are used, as indicated by the dotted lines 481 and 483.

The combination of financial functions and properties define the metagraph rules, i.e.—the specific flow of computations triggered into action when property values change.

In accordance with certain embodiments of the present invention, execution graphs are generated from the metagraph in realtime following trigger events (e.g. when a trading event happens in the market and its data is received in the system).

In accordance with other embodiments of the present invention, execution graphs may also be produced from the metagraph prior to the realtime event reception (e.g. before the trading hours).

The financial entity group and its associated sub-metagraph of FIG. 4 offer an efficient way to define the method by which market events for an unlimited number of financial entities are handled. The rules are defined once and from that point on apply to any financial event that matches the financial group criteria. For example, consider a case where there are 400 bonds issued by the US Government and traded in the different markets, a user may change the relevant sub-metagraph once to accomplish an effect on all those instruments at once. Furthermore, in case a new bond is issued by the US government, it will be handled by the system in a straightforward manner, with no added configurations required.

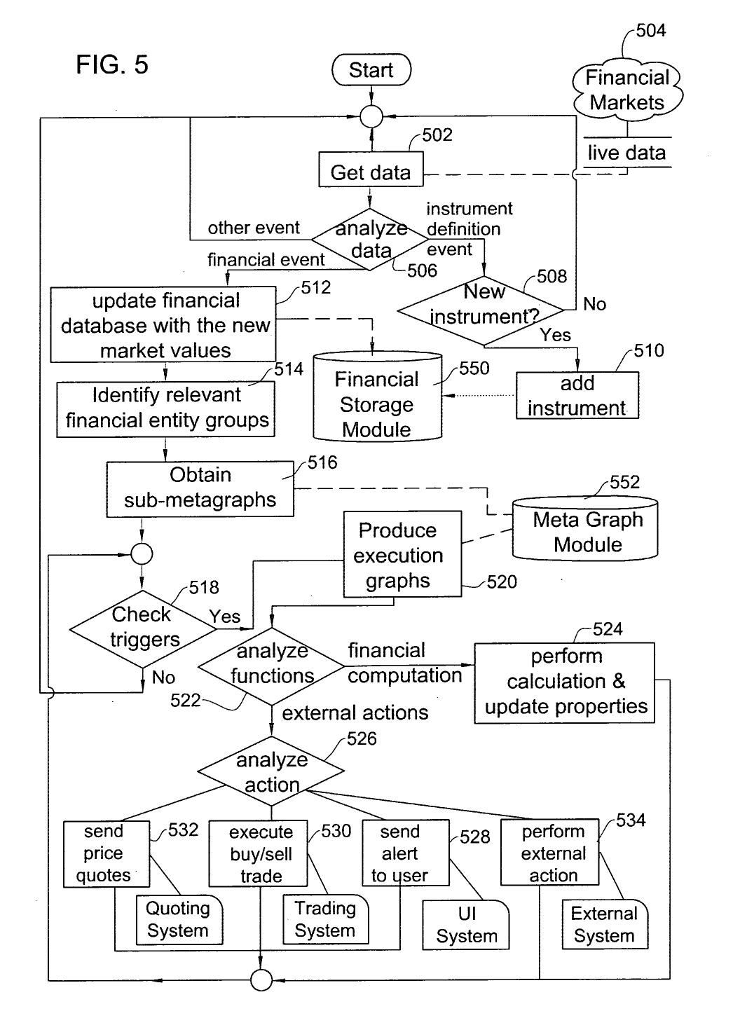

FIG. 5 is a flowchart diagram of a general sequence of operations of a system according to certain embodiments of the present invention.

The system awaits new data at step 502. In accordance with certain embodiments of the present invention, the data may be received from external sources such as the live financial market data 504. The data may also be entered by a user of the system or other internal systems.

In accordance with certain embodiments of the present invention, at operation 506, the received data is analyzed and categorized to one of the following categories:
a) Instrument definition events: This event type is provided periodically regarding currently tradable financial instruments. For example, in case there are currently 400 US government bonds traded in a market—then 400 definition events will be received periodically.
   For each instrument, associated data such as the issuer name, maturity date, the coupon it carries, etc. are received.
b) Financial events: these events relate to any live market data associated with a financial event such as the trading of a financial instrument. For example, the data may include the number of units of a certain bond that were sold, the traded price, the identification of the bond and the market arena in which the trade was conducted.
According to certain embodiments of the present invention, in step 506 it is checked whether the received data is an instrument definition event, financial event or another type of event. In case an instrument definition event is identified, in step 508 it is checked whether the corresponding financial instrument was previously defined in the system. In the case it was not previously defined (i.e. this is the first encounter with this particular financial instrument), it is added in step 510 to the financial storage module. For example, reverting to FIG. 2, upon the first time an instrument definition event is received for a financial entity, with the following data:
[Issuer=“US Gov”; Coupon=“5.50%”; Maturity=“05/10/2016”; market=“Bloomberg”]
A new row (224) is defined in the storage module for this new instrument, with the corresponding values and an instrument property ID (an internal reference number) is given the value 110.

In the case an event from the market is identified in step 506 as a financial event, in step 512 the corresponding values in the financial storage module are updated with the new received market values. The event data is scanned and the relevant values are stored in the financial storage module 550. Continuing the last example, in case a financial event is received from an online market, specifying that the financial entity that corresponds to row 224 in the storage module was traded in the Bloomberg market for the price of $98.77, the “Bloomberg price” property of row 224 is updated accordingly.

In step 514, the financial entity groups which are relevant to the received financial event data are identified by matching the received data to each group's criteria. Therefore, a list of relevant groups is produced. Continuing the last example, in case a financial event is received from an online market, specifying that the financial entity that corresponds to row 224 in the storage module was traded in the Bloomberg market for the price of $98.77, the financial entity is associated (among possible other groups) in this step with the group named “US Gov. Bonds” (shown in FIG. 4), since the data associated with this particular financial entity matches “US Gov. Bonds” criteria.

In step 516, sub-metagraphs associated with each of the relevant financial entity groups are obtained from the metagraph module 552. Continuing the last example, in this step metagraph module 552 receives a sub-metagraph request for any sub-metagraph defined for the group “US Gov. Bonds”. Since, as shown in FIG. 4, there is one sub-metagraph associated with this particular group, it is retrieved at this stage from the metagraph module 552.

In step 518 it is examined if any of the changes to values in the financial storage module trigger a re-computation or instruction to be executed. This is done by screening the sub-metagraphs obtained in step 516 for dependencies in the changed properties. Continuing the last example, in this step the sub-metagraph retrieved in the last step (the sub-metagraph of FIG. 4) is screened by relating each of the financial properties within it with the specific values of the financial entity, as represented by row 224 of FIG. 2. Since it is found that the “Bloomberg price” is a newly updated property and according to the sub-metagraph structure shown in FIG. 4 should lead to further computations of the property “estimated price” 476 and “Yield” 478, the result of this step is the decision that a trigger exists and therefore an execution graph should be produced and executed.

As another example, consider the case where an additional financial group termed “low yield” is defined with the criteria: “yield”<5%. In addition, consider a bond which is a member of the financial entity group “US Gov Bonds” 488 of FIG. 4 and has a “yield” equals to 5.2%. The bond is traded in the Bloomberg market, an event is received in the system and an execution graph is produced and executed. This execution graph in turn causes the “yield” value of the bond to decrease to the value 4.78%. The bond is therefore dynamically associated with the group “low yield”. In step 518 it is checked whether the dynamic association with this additional group triggers a re-computation or instruction to be executed due to additional sub-metagraphs associated with the group “low yield”.

If no trigger is found in this step, the system returns to step 502 and awaits new data.

In step 520 execution graphs are produced based on the relevant sub-metagraphs that relate to the re-computation or instruction to be executed as found in step 518. Returning to the example, an execution graph (schematically illustrated in FIG. 3) is produced, based on the received event. In this execution graph (which is based on the sub-metagraph of FIG. 4), the values of the properties “Bloomberg price” 352, “coupon” 366 and “maturity” 368 are inserted according to the information retrieved from the financial storage module (row 224 of FIG. 2). This example illustrates how a general sub-graph can serve as the template for numerous specific events related computations, suitable for any number of specific financial entities. The metagraph module (552) is used to identify all the financial functions that are part of the execution graphs to be executed.

In step 522, financial functions that are part of the execution graphs to be executed are analyzed as either financial computation functions or external actions.

Financial computation functions result in changes to values of other properties in the financial storage module, e.g. change to the “estimated price” value triggers the execution of the financial computation function “Price_to_Yield” that computes the “yield” for the bond according to its price. For example, in the execution graph of FIG. 3 both “Bloomberg_to_price” function 354 and “Price_to_yield” function 356 are financial computation functions.

External Actions are financial functions that call to other systems, in order to carry out an action that is not a computation, e.g—execute a trade, send a price quotation to the market or to a client, send an alerting message, etc.

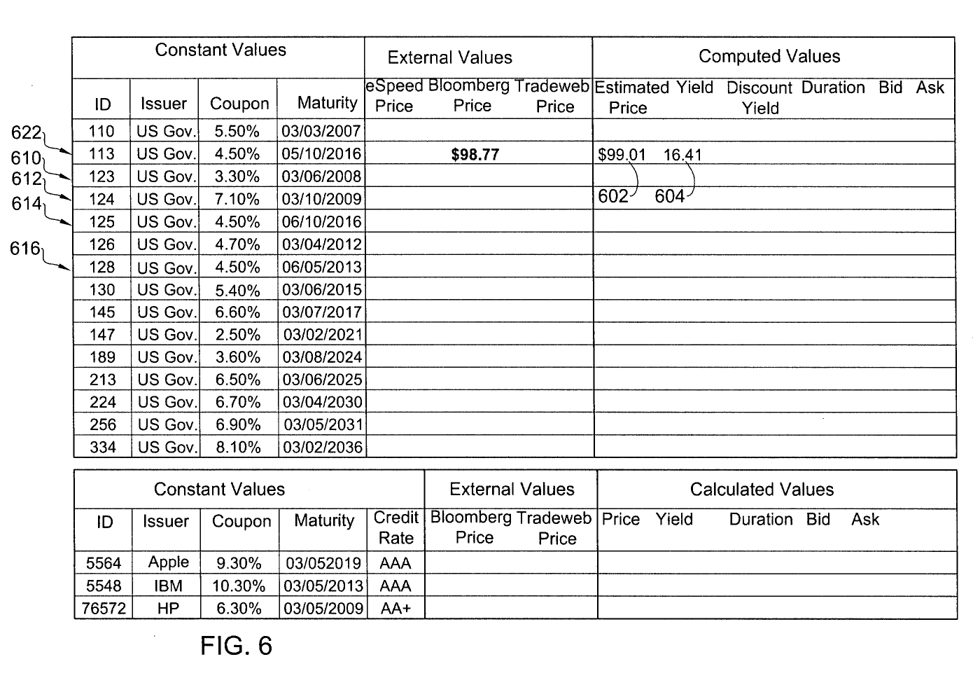

In step 524, in the case of financial computation functions, they will be executed and the corresponding financial storage module values will be updated in financial storage module 550. Continuing the example and drawing attention to FIG. 6, the outcome of step 524 is demonstrated in the schematic illustration of the financial storage module. The execution of the execution graph results in two computed values that are inserted to the database, namely the “estimated price” value 602 and the “yield” value 604.

The changed values can themselves become triggers for re-computation or an instruction to be executed as defined in the metagraph (i.e. create a “chain-reaction” of computations). This is expressed in FIG. 5 by the arrow leading from step 524 to step 518. Each time an execution graph is executed in step 524, an iterative loop leads to step 518 where again it is checked whether there are any changes to values in the financial storage module that trigger additional execution of execution graphs. In case no further re-computation or instruction to be executed is required, step 502 is taken, in which new received data is awaited. Returning to the example, the re-computation of the “yield” value 364 of FIG. 3 results in an update of the corresponding field in the financial storage module. This in return triggers a second execution graph production, based on the sub-metagraph shown in FIG. 4. In particular, the function “Yield_to_price” 484 that leads from Yield 478 to “estimated price” 476 is the base for an additional execution graph, triggered by the initial update of the “Yield” 478 value.

In the case of external actions functions, they are further analyzed in step 526, and the relevant system interfacing process will be carried out. For example, to send an alert message, a user interface module is called 528; to execute a trade, a trade execution system is called 530; to send a price quote to a client, a quoting system is called 532. Thus, using this interfacing approach, any system which can be interfaced can be called by function 534.

The use of the above described system will now be illustrated by way of a series of examples.

Reverting to FIG. 4, the sub-metagraph described therein defines the pricing logic for the financial entity group named “US government bonds”. As mentioned earlier, the purpose of the metagraph is to define the general way in which execution graphs are generated.

Returning to FIG. 3, an event in which a specific US Gov Bond (represented by row 224) is traded in the Bloomberg Arena at the price of $98.77 would cause a change in the property value “Bloomberg Price” of the specific instrument and since the instrument belongs to the financial entity group “US government Bonds” it would trigger the generation of price-related computations for this specific bond according to the sub-metagraph shown in FIG. 4. The execution graph of FIG. 3 is derived from the sub-metagraph shown in FIG. 4.

In the schematic illustration used to describe execution graphs, specific financial properties are presented as circles. The “known” values are written inside the circle (either constant values—such as the value of “Coupon” 366 or an external value that triggers the computation—$98.77 in the value “Bloomberg Price” 352). The arrows represent the financial functions that will be called and the empty circles represent the values to be computed (in this case—the values “estimated price” 362 and “yield” 364 will be computed).

Note that although the sub-metagraph of FIG. 4 includes the function “Yield_to_Price” 484, this function was not added to the execution graph of FIG. 3. In accordance with certain embodiments of the present invention, execution graphs do not include a second computation of any property. Thus, “loops” of functions computations are eliminated from the execution graph. The arrow representing the function “Yield_to_Price” 484 leads from the financial property “Yield” 478 to the financial property “estimated price” 476. This function will be represented in an execution graph in case for example where the value of “Yield” 478 would change (rather than the value of “Bloomberg price” 464), triggering the execution of the corresponding execution graph.

FIG. 6 is a schematic illustration of the simplified financial storage module representation of FIG. 2, in which the effect of the execution of the execution graph of FIG. 3 is illustrated, in accordance with certain embodiments of the present invention.

In this example, the new values of the financial properties “estimated Price” 602 and “Yield” 604 of the bond represented in row 224 were computed following the triggering market event. The new values are 99.01 for “estimated Price” 602 and 16.41 for “Yield” 604. This is the outcome of executing the corresponding execution graph, in step 524 of FIG. 5.

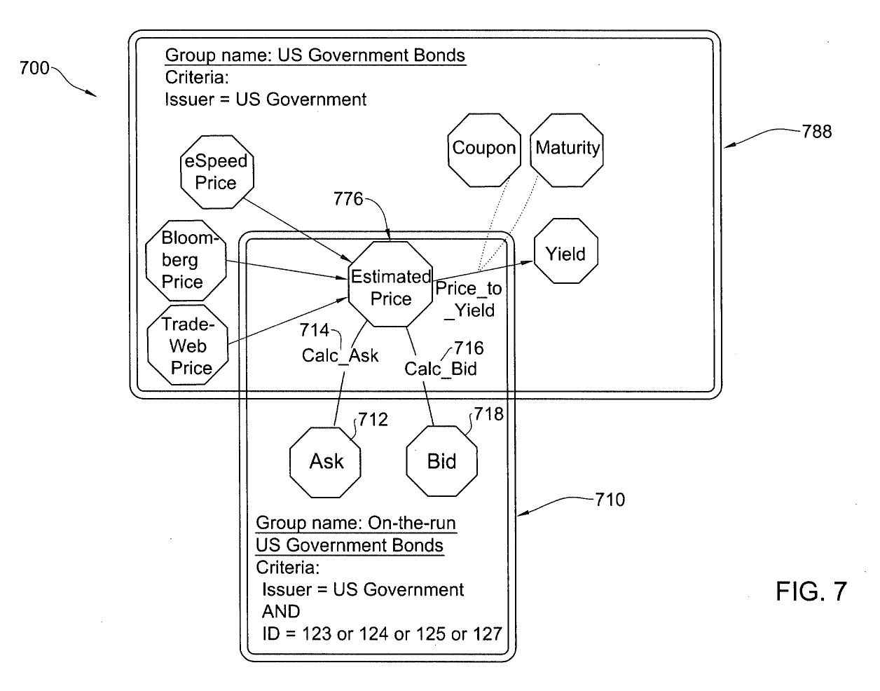

FIG. 7 is a schematic illustration of a sub-metagraph in accordance with certain embodiments of the present invention, based on the sub-metagraph of FIG. 4 wherein a second financial entity group and the corresponding sub-metagraph are introduced.

The second financial entity group name is “On-The-Run US Government Bonds” 710 and its criteria includes the first financial entity group (788) criteria (“issuer=US Government”) and a second condition (“ID=123 OR 124 OR 125 OR 126”). Therefore, the members of this financial entity group are the three instruments (ID=123, 124, 125) which are also members of the first financial entity group “US Government Bonds” 788. This example demonstrates the fact that a financial entity may belong to more than one group. Those four financial entities are represented by rows 610-614 in FIG. 6. The sub-metagraph which relates to the financial entity group “On-The-Run US Government Bonds” defines financial functions to the same “estimated Price” Property 776 that is also used in the sub-metagraph of the first Financial entity group. Therefore, in the sub-metagraph of financial entity group “US Government Bonds” 788, a change to the value of the “estimated price” property triggers the generation of the first execution graphs, and an additional execution graph is generated according to the sub-metagraph of financial entity group “On-The-Run” for the four specific instruments. The additional set of computations is defined by the two financial functions “Calc_ask” 714 which computes the value of property “Ask” 712 (The price a seller is willing to accept for a bond) based on the property “estimated price” 776 and the financial function “Calc_Bid” 716 which computes the value of property “Bid” 718 (the price at which a market maker is willing to buy a bond) based on the property “estimated price” 776. The market-maker makes a profit from buying and selling bonds—only if the sell price is higher than the buying price. These prices are known as Bid price (price to buy) and the Ask price (the price to sell).

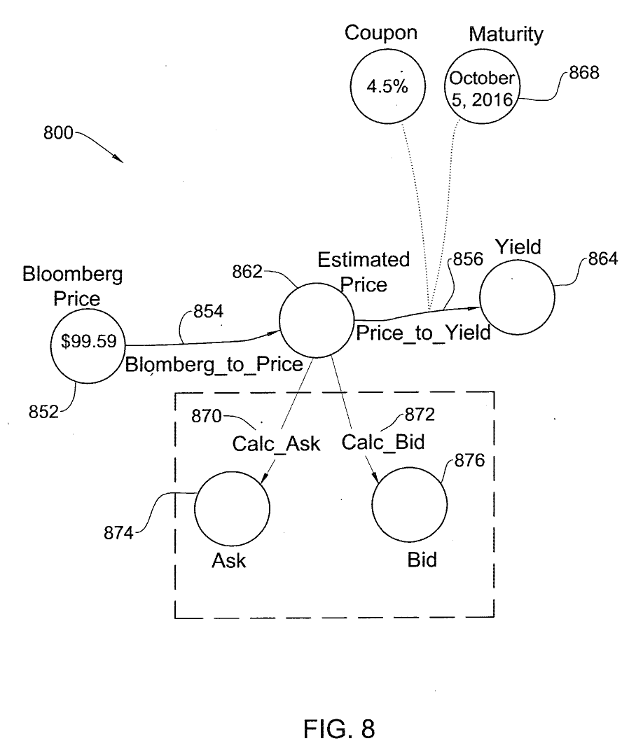

FIG. 8 is a schematic illustration of an execution graph corresponding to the sub-metagraph of FIG. 7, in accordance with certain embodiments of the present invention.

The execution graph 800 is produced as a result of a financial event received in the system in which the data specified is:

[Issuer=US Gov Bond; price=$99.59; Coupon=4.5%; Maturity=06/10/2016; market=Bloomberg]

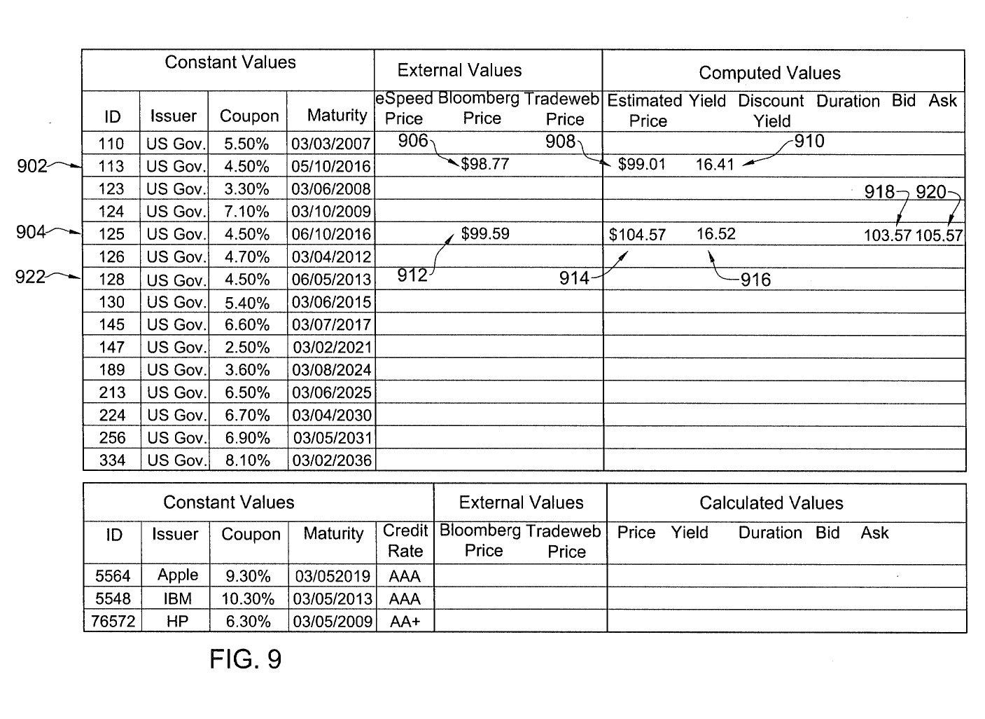

This data is used in step 514 of FIG. 5 where the group “On-The-Run US Government Bonds” (group 710 in FIG. 7) is identified as related to the financial event. This is because the received data includes values that fit the “On-The-Run US Government Bonds” criteria. Note that the data received in the financial event message is only part of the values needed to evaluate “On-The-Run US Government Bonds” group criteria. The value of the property ID is retrieved from the financial storage module itself rather than received in the message as will be explained in the description accompanying FIG. 9.

The execution graph 800 contains more instructions than the execution graph in the previous example in FIG. 3, since the sub-metagraph of financial entity group “On-The-Run US Government Bonds” (group 710 in FIG. 7) added more computations (financial functions and financial properties).

This execution graph is produced as was explained before, in step 520 of FIG. 5.

It includes the financial function “Bloomberg_to_Price” 854 that computes the “Bloomberg price” 852 and the result will be stored in the “estimated price” value 862. In a similar manner, once the “estimated price” value is changed, it causes the re-computation of another value: the “yield” value 864. The “yield” will be computed based on the estimated price value by the “Price_to_Yield” financial function 856. As explained before, function “Price_to_Yield” computes “yield” based on two additional parameters, namely the bond's attributes: “coupon” 866 and “maturity” 868. This is represented by the two broken lines leading from “coupon” 866 and “maturity” 868 to the “Price_to_Yield” function 856.

The addition of financial group 710 to the example (see FIG. 4) results in four new elements in execution graph 800 of FIG. 8 compared with execution graph 300 of FIG. 3, namely function “calc_ask” 870 that defines the computation of a value to the added property “Ask” 874 based on the property “estimated price” 862, and function “calc_bid” 872 that defines the computation of a value to the added property “Bid” 876 based on the property “Estimated price” 862.

As was previously explained, the execution graph is executed in step 524 of FIG. 5. The results of its execution are presented in FIG. 9.

FIG. 9 is a schematic illustration of the simplified financial storage module of FIG. 6, in which the effect of the execution of the execution graph of FIG. 8 is illustrated, in accordance with certain embodiments of the present invention.

The values of the financial entity represented by row 904 are computed. As defined by the execution graph 800 of FIG. 8, the trigger value “Bloomberg Price” 912 causes the re-computation of values: estimated price 914, Yield 916, Bid 918 and Ask 920.

As was previously explained, the data received in the financial event message that started the process is only part of the values needed to evaluate “On-The-Run US Government Bonds” group criteria. The value of the property ID of the particular financial entity represented by row 904 in the financial storage module is 125. This financial entity therefore matches the “On-The-Run US Government Bonds” financial group criteria and this is the reason this financial entity's related execution graph is executed.

To emphasize this point, note that the financial entity in row 922 shares the same values of fields Issuer, coupon and Maturity as the financial entity represented by row 904, but since its ID value is 128 it does not match the “On-The-Run US Government Bonds” financial group criteria and this is the reason this financial entity's related execution graph is not executed.

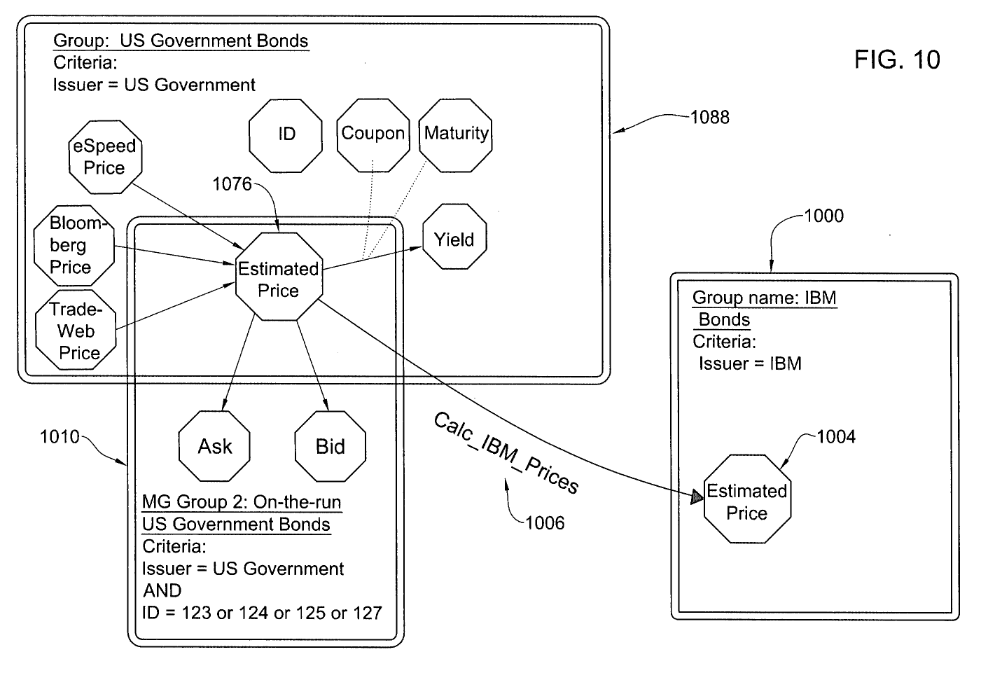

FIG. 10 is a representation of a sub-metagraph in accordance with certain embodiments of the present invention, based on the sub-metagraph of FIG. 7 wherein a third financial entity group named “IBM Bonds” 1000 and the corresponding sub-metagraph are introduced. The financial entity group's criteria is “Issuer=IBM”. The sub-metagraph includes the function “Calc_IBM_price” 1006. The function “Calc_IBM_price” 1006 defines the way to calculate the “estimated price” 1004 value of IBM issued bonds based on the “estimated price” 1076 property of members of groups “US Government Bonds” and “On-The-Run US Government Bonds”. Consider the case where “Calc_IBM_price” 1006 is defined as:

IBM bonds “estimated price”=US government bonds “estimated price”×0.90

I.e. the value of “estimated price” 1004 equals the value of “estimated price” 1076 multiplied by 0.9.

This example illustrates the way a change in the “estimated price” Property 1076 of instruments belonging to financial entity group “US Government Bonds” 1088 triggers a re-computation of properties related to financial entities that do not belong to the group “US Government Bonds” 1088, e.g. the property “estimated Price” 1004 of instruments belonging to the financial entity group “IBM Bonds” 1000.

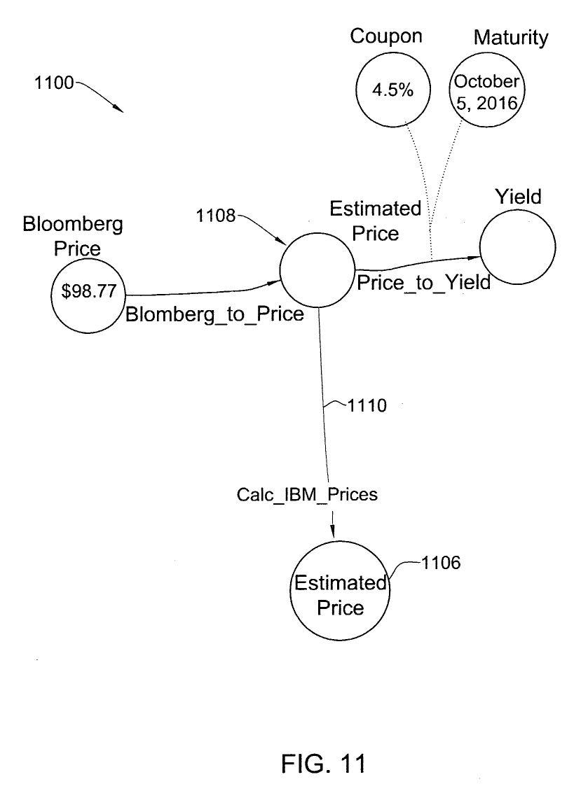

FIG. 11 is a schematic illustration of an execution graph corresponding to the sub-metagraph of FIG. 10, in accordance with certain embodiments of the present invention.

The execution graph 1100 is produced as a result of a financial event received in the system from the Bloomberg market, in which the data specified is:

[“issuer”=US Gov Bond; “estimated price”=$98.77; “coupon”=4.5%; “maturity”±05/10/2016]

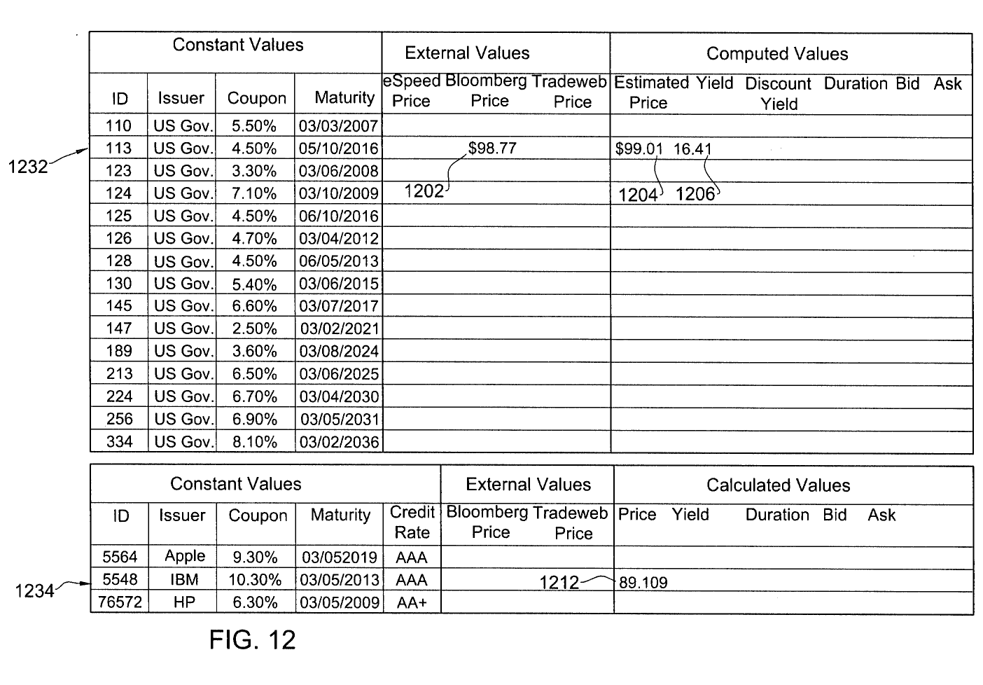

This data is used in step 514 of FIG. 5 where the group “US Government Bonds” (group 710 in FIG. 7) is identified as related to the financial event. This is because the received data includes values that match the “US Government Bonds” criteria. The group “US Government Bonds” related sub-metagraph includes the financial function “Calc_IBM_price” 1006, that connects the property “estimated price” 1076 to the property “estimated Price” 1004. Therefore, when the execution graph 1100 of FIG. 11 is produced, it includes the computation of the “estimated price” value for relevant members of the group “IBM bonds”. This includes “Calc_IBM_price” 1110 that leads to the computation of “estimated Price” 1106 that belongs to financial entity represented by row 1234 of FIG. 12.

FIG. 12 is a schematic illustration of financial storage module, in which the effect of the execution of the execution graph of FIG. 11 is illustrated, in accordance with certain embodiments of the present invention.

When the trigger value 1202 is updated, the execution graph causes the values “estimated price” 1204 and “yield” 1206 to be recomputed, as well as the “estimated price” value 1212 of the relevant member of the financial entity group “IBM Bonds”.

It will be understood that according to the invention the system may be a suitable programmed computer. Likewise, the invention contemplates a computer program being readable by a computer for executing the method of the invention. The invention further contemplates a machine-readable memory tangibly embodying a program of instructions executable by the relevant apparatus for performing and executing the method and the subject matter of the invention.

Unless specifically stated otherwise, as apparent from the following discussions, it is appreciated that throughout the specification discussions, utilizing terms such as, “processing”, “computing”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may use terms such as, processor, computer, storage, database, apparatus, system, sub-system, module, unit and device (in single or plural form) for performing the operations herein. This may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes/devices (or counterpart terms specified above) and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description. In addition, embodiments of the present invention are not described with reference to any particular programming language. It will be appreciated that a variety of programming languages may be used to implement the teachings of the inventions as described herein.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

With specific reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Features of the present invention which are described in the context of separate embodiments may also be provided in combination in a single embodiment. Conversely, features of the invention which are described for brevity in the context of a single embodiment may be provided separately or in any suitable sub-combination

The present invention has been described, with a certain degree of particularity, but those versed in the art will readily appreciate that various variations, alterations and modifications may be carried out, without departing from the scope of the above description and/or the following Claims:

1. A method for managing financial data, the method comprising:
a) providing at least one financial entity group having at least one group criterion, said financial entity group being associated with at least one sub-metagraph;
b) obtaining financial data;
c) relating said financial data to at least one of said financial entity groups if said financial data complies with said group criterion thereby giving rise to at least one relevant financial entity group;
d) obtaining sub-metagraphs associated with said relevant financial entity groups giving rise to relevant sub-metagraphs;
e) deriving execution graphs from said relevant sub-metagraphs; and
f) executing said execution graphs
whereby financial information is updated and financial actions are performed according to said financial data.

2. The method according to claim 1 wherein:
a) said sub-metagraph comprises one or more financial properties; and said method further comprising:
b) iteratively, as long as a value of one or more of said financial properties changes following an execute of an execution graph, giving rise to changed financial properties:
i. relating said changed financial properties with at least one of said financial entity groups thereby giving rise to at least one related financial entity group;
ii. obtaining sub-metagraphs associated with said related financial entity groups giving rise to related sub-metagraphs;
iii. deriving execution graphs from said relevant sub-metagraphs giving rise to additional execution graphs; and
iv. executing said additional execution graphs.

3. The method according to claim 2 wherein at least one pair of said financial properties are interlinked by a financial computation function, said financial computation function defining a dependency between one of said financial properties and the other.

4. The method according to claim 1 wherein said sub-metagraph includes at least one external action.

5. The method according to claim 4 wherein said external action is of type taken from a group comprising: trade execution, price quotation, alerting message.

6. The method according to claim 1 wherein more than one of said execution graphs are derived from one of said relevant sub-metagraphs.

7. The method according to claim 2 wherein at least one of said financial properties is a constant financial property, associated with a constant value which is not re-computed.

8. The method according to claim 2 wherein at least one of said financial properties is an external financial property, associated with a value that is updated by said financial data.

9. The method according to claim 2 wherein at least one of said financial properties is a computed financial property, associated with a value that is continuously computed according to said sub-metagraph.

10. A system for managing financial data, the system comprising:
a financial storage module storing financial properties values;
a metagraph module storing at least one sub-metagraph;
a computation module;
a metagraph complier module operatively coupled to said financial storage module, said metagraph module and said computation module;
wherein said complier module is operatively configured to:
a) obtain at least one sub-metagraph from said metagraph module, said at least one sub-metagraph comprising at least one financial property;
b) obtain values associated with said at least one financial property from said financial storage module;
c) produce at least one execution graph based on said at least one sub-metagraph and said values; and
d) send said at least one execution graph to said computation module for execution thereby;
whereby financial information is updated and financial actions are performed according to said financial data.

11. The system of claim 10 wherein said financial storage module is operatively coupled to an external data link thereby receiving updated financial properties values from external sources.

12. The system of claim 11 wherein said financial storage module is comprising an external values module, said external values module storing said updated financial properties values.

13. The system of claim 10 wherein said financial storage module further comprises a computed values module storing values computed by said system.

14. The system of claim 10 wherein said financial storage module comprises an external values module, said external values module storing values updated directly from financial data.

15. A system for managing financial data, the system comprising:
a financial storage module storing financial properties values;
a metagraph module storing at least one sub-metagraph;
a computation module;
a metagraph complier module operatively coupled to said financial storage module, said metagraph module and said computation module;
wherein said complier module is operatively configured to:
a) receive one or more financial entity groups, each having at least one group criterion, said financial entity group being associated with at least one sub-metagraph;
b) obtain financial data from said financial storage module;
c) relate said financial data with at least one of said financial entity groups if said financial data complies with said group criterion thereby giving rise to at least one relevant financial entity groups;
d) obtain sub-metagraphs associated with said relevant financial entity groups from said metagraph module giving rise to relevant sub-metagraphs;
e) derive execution graphs from said relevant sub-metagraphs; and
f) send said execution graphs for execution in said computation module;
whereby financial information is updated and financial actions are performed according to said financial data.

16. A program storage device readable by machine, tangibly embodying a program of instructions executable by the machine to perform method steps for managing financial data, the method comprising:
a) providing at least one financial entity group having at least one group criterion, said financial entity group being associated with at least one sub-metagraph;
b) obtaining financial data;
c) relating said financial data to at least one of said financial entity groups if said financial data complies with said group criterion thereby giving rise to at least one relevant financial entity group;
d) obtaining sub-metagraphs associated with said relevant financial entity groups giving rise to relevant sub-metagraphs;
e) deriving execution graphs from said relevant sub-metagraphs; and
f) executing said execution graphs.

17. A computer program product comprising a computer useable medium having computer readable program code embodied therein for managing financial data, the computer program product comprising:
a) computer readable program code for causing the computer to provide at least one financial entity group having at least one group criterion, said financial entity group being associated with at least one sub-metagraph;
b) computer readable program code for causing the computer to obtain financial data;
c) computer readable program code for causing the computer to relate said financial data to at least one of said financial entity groups if said financial data complies with said group criterion thereby giving rise to at least one relevant financial entity group;
d) computer readable program code for causing the computer to obtain sub-metagraphs associated with said relevant financial entity groups giving rise to relevant sub-metagraphs;
e) computer readable program code for causing the computer to derive execution graphs from said relevant sub-metagraphs; and
f) computer readable program code for causing the computer to execute said execution graphs.

18. A method for managing financial data, the method comprising:
a) providing consolidated business scenarios that pertain to at least one financial instrument;
b) receiving financial data that pertain to at least one financial instrument;
c) checking if the financial data relates to at least one of the consolidated business scenarios giving rise to relevant business scenarios; and
d) computing the relevant business scenarios;
whereby financial information is updated and financial actions are performed according to said financial data.

19. The method according to claim 18 wherein the consolidated business scenarios are sub-metagraphs.

20. The method according to claim 18 wherein said financial data pertains to at least one financial instrument if said financial data complies with at least one condition, said condition associated with at least one financial entity group, said group embraces the financial instrument and at least one of the consolidated business scenarios.

21. The method according to claim 18 wherein said relevant business scenarios are execution graphs.

22. A program storage device readable by machine, tangibly embodying a program of instructions executable by the machine to perform method steps for managing financial data, the method comprising:
a) providing consolidated business scenarios that pertain to at least one financial instrument;
b) receiving financial data that pertain to at least one financial instrument;
c) checking if the financial data relates to at least one of the consolidated business scenarios giving rise to relevant business scenarios; and
d) computing the relevant business scenarios;
whereby financial information is updated and financial actions are performed according to said financial data.

23. A computer program product comprising a computer useable medium having computer readable program code embodied therein for managing financial data, the computer program product comprising:
computer readable program code for causing the computer to provide consolidated business scenarios that pertain to at least one financial instrument;
computer readable program code for causing the computer to receive financial data that pertain to at least one financial instrument;
computer readable program code for causing the computer to check if the financial data relates to at least one of the consolidated business scenarios giving rise to relevant business scenarios; and
computer readable program code for causing the computer to compute the relevant business scenarios;
whereby financial information is updated and financial actions are performed according to said financial data.
